(19) United States
(12) Patent Application Publication
(10) Pub. No.: US 2011/0028661 A1
(43) Pub. Date: Feb. 3, 2011

(54) HYBRID POLYURETHANE BLOCK COPOLYMERS WITH THERMOPLASTIC PROCESSABILITY AND THERMOSET PROPERTIES

(75) Inventors: Robert S. Ward, Lafayette, CA (US); Keith R. McCrea, Walnut Creek, CA (US); Yuan Tian, Alameda, CA (US); Jim Yang, Berkeley, CA (US)

Correspondence Address: BIRCH STEWART KOLASCH & BIRCH, PO BOX 747, FALLS CHURCH, VA, 22040-0747, US

(73) Assignee: DSM IP Assets B.V., Heerlen (NL)

(21) Appl. No.: 12/809,212

(22) PCT Filed: Dec. 18, 2008
(86) PCT No.: PCT/US08/87388

§ 371 Date: Sep. 21, 2010

Related U.S. Application Data
(60) Provisional application No. 61/015,403, filed on Dec. 20, 2007.

(51) Int. Cl. C08F 283/12

(52) U.S. Cl. 525/453

(57) ABSTRACT

Block copolymers are formulated with multifunctional chain extenders. The block copolymers include a soft segment and a hard segment made from a diisocyanate, an alkylene diamine chain extender, and a multifunctional chain extender which provides delayed crosslinking. The multifunctional chain extenders have a functionality and typically have at least one OH group. The multifunctional chain extenders may be aliphatic or aromatic triols or polyols, or may have other configurations, as described. The resulting block copolymers have improved mechanical properties such as compression set. They may be used in medical applications, or in industrial applications such as seal and gasket applications, including O-rings, window seals, and automotive gaskets. The initially-formed polyurethane resin behaves as a thermoplastic processable material, while the configured end-use product is thermoset.

### FIELD OF THE INVENTION

The present invention relates to novel polyurethane block copolymers, and to methods of manufacturing them. The novel block copolymers of the present invention are formulated with multifunctional chain extenders. The resulting block copolymers are characterized by improved mechanical properties such as compression set. They may be used in medical applications, or in industrial applications such as seal and gasket applications, including O-rings, window seals, and automotive gaskets.

### BACKGROUND OF THE INVENTION

In general, thermoplastic urethane (TPU) material marketed for gaskets and seals use aromatic diisocyanates to maximize intermolecular forces between the hard segments, which lead to improved compression set properties. However, aliphatic polyurethanes with improved compression set are desirable for their optical properties. It is therefore important to improve the intermolecular forces between polymer chains through chemical, physical or ionic crosslinks of aliphatic materials.

Vulcanized rubber performs very well during compression set testing due to the high degree of chemical crosslinks. However, vulcanized rubber is not thermoplastic and can not be extruded or injection molded. Therefore, there is much interest in a good compression set TPU for high compression applications such as seals or gaskets.

Aliphatic diisocyanates based TPUs are desirable over their aromatic based counterparts because they do not discolor from exposure to ultraviolet light. It is known that aromatics provide polyurethane materials with considerably improved compression set properties. However, aliphatic isocyanate based TPUs generally exhibit very poor compression set due to weaker intermolecular forces compared to aromatic isocyanates. Chemical, physical, or ionic crosslinks are required to improve the compression set of such materials.

### SUMMARY OF THE INVENTION

The present invention synthesizes a TPU which will chemically crosslink after it is thermoprocessed and aged or annealed. This novel TPU is based on the combination of a diamine chain extender, such as DYTEK A or ethylene diamine, and a multifunctional (functionality ≧3) chain extender, preferably with at least one OH group. It can be used to improve thermoplastic processability while improving compression set by taking advantage of the different reaction rates of the hydroxyl groups versus the diamines.

During continuous reaction, a structural low molecular weight (MW) polymer using a diamine chain extender may be synthesized to allow for processability. A trifunctional polyol chain extender or other multi-functional chain extender may be introduced but not completely reacted (no catalyst is introduced). Residence time in the reactor must not be too long. Because of the polymer's low molecular weight, it will be processable. After processing, the formed device may be cured at elevated temperatures or by aging to increase the molecular weight by initiating crosslinking between unreacted isocyanate groups and residual unreacted hydroxyl groups from the trifunctional or multi-functional chain extenders.

In effect, the present invention provides a hybrid resin, preferably a polyurethane resin, that has both thermoplastic and thermoset properties at different times in its life cycle. The initially-formed polyurethane resin behaves as a thermoplastic processable material, while the configured end-use product is thermoset.

### DETAILED DESCRIPTION OF THE INVENTION

In one embodiment, this invention provides a block copolymer having improved compression set, which block copolymer comprises a soft segment and a hard segment made from a diisocyanate, an alkylene diamine chain extender, and a multifunctional chain extender which provides delayed crosslinking.

The multifunctional chain extender feature of this invention has a functionality ≧3 and preferably has at least one OH group. This multifunctional chain extender may be an aliphatic or aromatic triol or polyol. This multifunctional chain extender may be a trifunctional polyol chain extender in which there are two primary alcohols and a one secondary alcohol, for instance, a polyether triol chain extender that has the formula HO—X(OH)—OH wherein X is an polyalkylene oxide moiety, such as VORANOL 230-660, a trifunctional polyol that has a molecular weight of 250. Preferably, one of the OH groups in said polyether triol chain extender is a secondary alcohol. The multifunctional chain extender may alternatively be a polyether chain extender that has the formula (H₂N)ₘ—X —(OH)ₙ wherein X is an polyalkylene oxide moiety and m and n are integers from 1 to 8.

In accordance with the present invention, the block copolymer may comprise 40-98 weight-% soft segment and 2-60% hard segment, in which 70-95% of the chain extender in the hard segment is difunctional and 5-30% is multifunctional.

The hard segment of the block copolymer of this invention may be made with a diisocyanate having the formula OCN—R—NCO. Suitable such isocyanates may be alkyl diisocyanates, arylalkyldiiocyanates, alkyl-cycloalkyl diisocyanates, alkylaryl diisocyanates, cycloalkyl diisocyanates, aryl diisocyanates, and cycloalkylaryl diisocyanates. A particularly suitable diisocyanate is isophorone diisocyanate. The alkylene diamine chain extender used to make the hard segment preferably is one of the formula H₂N—R′—NH₂ in which R is a divalent alkylene moiety having from 2 to 20 carbon atoms. A particularly suitable alkylene diamine chain extender is 2-methylpentamethylenediamine, commercially available as DYTEK A (2-methylpentamethylenediamine) from INVISTA GmbH of Hattersheim, Germany.

The present invention also provides a manufacturing method for making the novel block copolymers disclosed herein. The method may include, for instance, combining 40-98 weight-% soft segment component with 2-60 weight-% hard segment component, wherein, in said hard segment component, 70-95% of the chain extender is difunctional and 5-30% of the chain extender is multifunctional to form a partially crosslinked article; and maintaining that partially crosslinked article at or below room temperature for at least 24 hours. In a specific example, the method of this invention may include the steps of: providing a reaction vessel containing tetrahydrofuran solvent, rapidly adding to said solvent in said reaction vessel, in the absence of catalyst, 45 weight-% PDMS 3345, 35 weight-% isophorone diisocyanate, 15 weight-% DYTEK A chain extender, and 5 weight-% VORANOL 230-660 chain extender, at 22° C., and removing the resulting polymer from the reaction vessel after 15 minutes of adding the reactants thereto. In another specific example, the method may include the step of: synthesizing in bulk using continuous reactive extrusion by metering into a twin screw extruder with a screw speed of 200 rpm a formulation made up with 80% PDMS 3345, 15.5% IPDI, 3.3% Dytek A, and 1.2% Voranol and at 190° C.

Yet another embodiment of the present invention is the polymeric products described herein, configured as useful articles (e.g., as prosthetic spinal discs).

### Block Copolymers

The present invention provides block copolymers, which include a soft segment, a diisocyanate-based hard segment, the hard segment also including an alkylene diamine chain extender and a multifunctional chain extender which provides delayed crosslinking. The block copolymers of this invention are characterized by improved compression set.

The soft segment used in the preparation of the block copolymers of the invention may be a polyfunctional aliphatic polyol, or a polyfunctional aliphatic or aromatic amine such as are commonly used for the preparation of polyurethanes. The molecular weight of the soft segment is typically about 200 to 1,000,000, and preferably about 400 to 9,000.

Aliphatic polyol soft segment components may be selected from linear and branched polyalkylene and polyalkenyl oxides, random and block copolymers thereof, polycarbonate polyols, hydroxyl-terminated silicones, random and block copolymers thereof with polyalkylene oxides, linear and branched polyalkenyl and polyalkylene polyols, and mixtures thereof.

Examples of polyols that are suitable for use in the present invention are polyethylene oxides, polypropyleneoxides, polytetramethylene oxides, random or block polypropylene oxide-polyethylene oxide copolymers, various ethyleneoxide-terminated polyols, random or block polytetramethylene oxide-polyethylene oxide copolymers, polycarbonate diols and triols, multifunctional hydroxyalkyl- or amine-terminated silicones, random or block silicone-polyethyleneoxide copolymers, polybutadiene diols and triols, polyisobutylene diols and triols, and mixtures thereof.

Amine soft segment components may be selected from the group consisting of amine-terminated homologues of the above polyols, including but not limited to polyamine-terminated alkylene oxides and random and block copolymers thereof, polyamine-terminated silicones, random and block copolymers thereof with polyalkylene oxides and mixtures thereof.

Examples of the amines that are suitable for use in the present invention are multifunctional amine-terminated polytetramethylene oxides, multifunctional amine terminated polyethylene oxides, random or block multifunctional amine terminated polypropylene oxide-polyethylene oxide copolymers, random or block multifunctional amine-terminated polytetramethylene oxide-polyethylene oxide copolymers, multifunctional amine-terminated silicones, random or block amine-terminated silicon polyethylene oxide copolymers and mixtures thereof.

Particularly suitable polydimethylsiloxanes for making the soft segments of the block copolymers of the present invention are, without limitation, those having the formula

NH₂(CH₂)₃—Si(CH₃)₂—O—[Si(CH₃)₂—O]ₙ—Si(CH₃)₂—(CH₂)₃NH₂

wherein n=0 to 500. A typical embodiment thereof is PDMS 3345, which is commercially available from Wacker-Chemie GmbH of Munich, Germany.

Suitable polyisocyanates for the preparation of the hard segment of the copolymer of the invention are aromatic or aliphatic polyisocyanates. The organic diisocyanates may be selected from the group consisting of alkyl diisocyanates, arylalkyl diisocyanates, cycloalkylalkyl diisocyanates, alkylaryl diisocyanates, cycloalkyl diisocyanates, aryl diisocyanates, cycloalkylaryl diisocyanates, all of which may be further substituted with oxygen, and mixtures thereof.

Examples of suitable polyisocyanates are 4,4′-diphenylmethane diisocyanate, hexamethylene diisocyanate, dicyclohexylmethane diisocyanate, 2,4-toluene diisocyanate, 2,6-toluene diisocyanate, hexamethylene-1,6-diisocyanate, tetramethylene-1,4-diisocyanate, cyclohexane-1,4-diisocyanate, naphthalene-1,5-diisocyanate, diphenylmethane-4,4′-diisocyanate, xylylene diisocyanate, dicyclohexylmethane-4,4′-diisocyanate, 1,4-benzene diisocyanate, 3,3′-dimethoxy-4,4′-diphenyl diisocyanate, m-phenylene diisocyanate, isophorone diisocyanate, polymethylene polyphenyl diisocyanate, 4,4′-biphenylene diisocyanate, 4-isocyanatocyclohexyl-4′-isocyanatate, and mixtures thereof.

The primary chain extender of the hard segment used in the preparation of the copolymers of the invention may be an aliphatic diol or an aliphatic or aromatic diamine such as those known for preparing polyurethanes.

The polyol for the hard segment may be selected from alkylene, cycloalkylene, and arylene diols and mixtures thereof. Examples of polyols suitable for the preparation of the hard segment are 1,4-butanediol, ethylene glycol, 1,6-hexanediol, 1,4-cyclohexane dimethanol, phenyl diethanolamine, and mixtures thereof, among others. However, other polyols are also suitable.

The diamine of the hard segment may be selected from the group consisting of alkyl, cycloalkyl and aryl amines which may be further substituted with N, O, or halogen, complexes thereof with alkali metal salts, and mixtures thereof. Suitable diamines for preparing the hard segment are p,p′-methylene dianiline and complexes thereof with alkali metal chlorides, bromides, iodides, nitrites and nitrates, 4,4′-methylene-bis(2-chloroaniline), piperazine, 2-methylpiperazine, oxydianiline, hydrazine, ethylenediamine, hexamethylenediamine, xylylenediamine, bis(p-aminocyclohexyl)methane, dimethyl ester of 4,4′-methylenedianthranilic acid, p-phenylenediamine, m-phenylenediamine, 4,4′-methylene bis(2-methoxyaniline), 4,4′-methylene bis(N-methylaniline), 2,4-toluenediamine, 2,6-toluenediamine, benzidine, dichlorobenzidine, 3,3′-dimethylbenzidine, 3,3′-dimethoxybenzidine, diansidine, 1,3-propanediol bis(p-aminobenzoate), isophorone diamine, and mixtures thereof.

The copolymer of the invention may be prepared in a wide range of molecular weights. Molecular weights may range from 5000 to 1,000,000, and preferably from about 10,000 to 100,000.

The preparation of block copolymers is in general well known to persons skilled in the art. Particularly useful disclosures may be found in U.S. Pat. No. 5,428,123, the contents of which are incorporated by reference herein.

### Multifunctional Chain Extenders

In accordance with the present invention, a multifunctional chain extender comprising at least one hydroxyl group is used to create chemical crosslinks after a device or part is fabricated. The amine groups will quickly react with the di-isocyanate and as long as a catalyst is not used, the reaction rate between isocyanate groups and hydroxyl groups will be slow enough to prevent crosslinking during synthesis and processing. Only after the material has been configured into a part and cured by aging or at elevated temperature will the reaction complete by forming chemical crosslinks between unreacted hydroxyl and isocyanate groups.

The multifunctional chain extender of the hard segment used in the preparation of the copolymers of the invention may be an aliphatic or aromatic triol or polyol. The multifunctional polyol for the hard segment may be selected from polyether polyols, polyester polyols, acrylic and alkyd polyols, and mixtures thereof.

Examples of polyols suitable for the preparation of the hard segment are glycerol, trimethylol propane, trimethylol ethane, pentaerythritol, ethanolamine, N-methyldiethanolamine, Mannich polyols, oxypropylated triols, sorbitol (hexahydroxyhexane), 2,2-bis(hydroxylmethyl)-3-propanol ether, and mixtures thereof, among others. However, other multifunctional polyols are also suitable.

During synthesis, a structural polymer can be produced using a soft segment, di-isocyanate, and a diamine chain extender while a multifunctional functional polyol is ‘compounded’ into the melt during the reaction. Some of the alcohol groups may react, but many if not most of the groups will not react during the residence time of the polymer in the extruder. The alcohol and excess isocyanate groups will react once they are cured at high temperature after fabrication of a useful article, thus creating chemical crosslinks.

The strategy of using a trifunctional polyol as a post fabrication crosslinking agent improves compression set. Although it appears that most crosslinking occurred during curing, it is likely that some of the polyol did react and crosslinked during synthesis. It is also likely that some crosslinking occurs during the processing step of creating compression set discs.

VORANOL 230-660 contains three primary alcohols. To control crosslinking during reaction or processing, a trifunctional polyol chain extender may be used in which there are two primary alcohols and a one secondary alcohol. The secondary alcohol would react much more slowly and likely improve the shelf life of the unconfingured polymer. The secondary alcohol would then react only during curing at elevated temperatures after a device was fabricated.

Generally, polyurethanes with urea groups synthesized from the reaction of amines with isocyanate, are not ideal for thermoplastic processing due to their elevated melting temperature. In fact, a polyurea-urethanes can have degradation temperatures above its melting point. Therefore, only a small concentration of amine groups can be used within a given formulation if the material is to be thermoplastic. A balance must be made between the use of reactive amine and hydroxyl groups to obtain the desired effect of post fabrication chemical crosslinks. Enough amine must be used to create a structural material so it can be injection molded or extruded.

### Compression Set

The permanent deformation remaining after release of a compressive stress is defined as Compression Set. Compression set is expressed as the percentage of the original deflection. Compression set is an important property for elastomers and cushioning materials. To evaluate the compression set of the present formulations, a Compression Set apparatus may be assembled based on ISO 815. This includes the design and manufacturing of a mold capable of producing samples required in ISO 815. All of the compression set tests reported herein were performed using 25% strain at 70° C. for 22 hours.

The test specimen is compressed for a specified time at a specified temperature. Compression Set is calculated as the percentage of the original deflection after the material is allowed to recover at standard conditions for 30 minutes. Compression set is calculated using the formula: C=[(hₒ−hᵢ)/(hₒ−hₙ)]*100 where hₒ is the original specimen thickness, hᵢ is the specimen thickness after testing, and hₒ is the spacer thickness.

DEFINITION. In accordance with the present invention, a polymer has “improved compression set” when its compression set can be decreased by at least 5% by aging at 25° C. for 72 hours.

### Compression Set Examples

A strain of 25% may be used for testing. Test specimens may be cylindrical discs 29.0 mm in diameter and 12.5 mm in thickness, cut from a slab of the testing material.

Compression set discs are fabricated in accordance with the present invention. They have a compression set of >98% without elevated temperature curing. When the discs made from the same material are treated at 100° C. for 24 hours, the compression set is improved to 77%. To determine the effect of aging the samples at room temperature, discs are left at room temperature for 72 hours before compression set testing. The aged samples exhibit a compression set of 92%. These results are summarized in the following Table.

| | | | Tensile | |
|---|---|---|---|---|
| | | Compression | Strength | |
| | Lot | Set | (PSI) | Hardness |
| No aging or curing | 570014 | 99% | 801 | 67 |
| Curing (24 hours 100 C) | 570014 | 77% | | |
| Aging (72 hours 25 C) | 570014 | 92% | | |

10% Hard Segment, PDMS 3345, Dytek A:Voranol (4:1)

### EXAMPLES

### Example 1

In a formulation of this invention, VORANOL 230-660, a trifunctional polyol with a MW of 250, replaces some of the DYTEK A diamine chain extender in a formulation based on PDMS 3345, DYTEK A, and isophorone diisocyanate (IPDI), with a hard segment content of 10%. This example may employ, for instance, a 4:1 ratio of DYTEK-A to VORANOL.

### Example 2

A formulation according to the present invention consists of 45 weight-% PDMS 3345, 35 weight-% isophorone diisocyanate, 15 weight-% DYTEK A chain extender, and 5 weight-% VORANOL 230-660 chain extender. The formulation is placed in a reaction vessel containing tetrahydrofuran solvent. More specifically, the formulation is rapidly adding to the solvent in the reaction vessel, in the absence of catalyst. One-quarter hour after placing the ingredients in the reaction vessel, they are removed therefrom, and solvent is distilled off.

### Example 3

A polymer having improved compression set in accordance with the present invention is made from 80% PDMS 3345, 15.5% IPDI, 3.3% DYTEK A, and 1.2% VORANOL. The polymer is synthesized in bulk using continuous reactive extrusion by accurately metering the listed ingredients into a twin screw extruder at a temperature of 190° C. employing a screw speed of 200 rpm.

### Industrial Applicability

These materials can be used where TPUs are commonly used for in either medical or industrial applications. In addition, these materials can be used in seal, gasket, or load bearing applications, such as O-rings, window seals, and automotive gaskets. Medical applications include bearing materials in orthopedic applications such as prosthetic spinal discs or hip or knee implants.

The device or prosthesis in these embodiments configured as an implantable medical device or prosthesis or as a non-implantable disposable or extracorporeal medical device or prosthesis or as an in vitro or in vivo diagnostic device, wherein said device or prostheses has a tissue, fluid, and/or blood-contacting surface. In these devices or prostheses, the polymer body may be a dense or microporous membrane component in an implantable medical device or prosthesis or in a non-implantable disposable or extracorporeal medical device or prosthesis or as an in vitro or in vivo diagnostic device, and wherein, when said polymer body comprises a membrane component in a diagnostic device, said component contains immuno-reactants.

The device or prosthesis of this invention can comprise a blood gas sensor, a compositional sensor, a substrate for combinatorial chemistry, a customizable active biochip, a semiconductor-based device for identifying and determining the function of genes, genetic mutations, and proteins, a drug discovery device (wherein the drug is complexed to surface-modifying endgroups and is released through diffusion or wherein the drug is associated with, complexed to, or covalently bound to surface-modifying endgroups that degrade and release the drug over time), an immunochemical detection device, a glucose sensor, a pH sensor, a blood pressure sensor, a vascular catheter, a cardiac assist device, a prosthetic heart valve, an artificial heart, a vascular stent, a prosthetic spinal disc, a prosthetic spinal nucleus, a spine fixation device, a prosthetic joint, a cartilage repair device, a prosthetic tendon, a prosthetic ligament, a drug delivery device from which drug molecules are released over time, a drug delivery coating in which drugs are fixed permanently to polymer endgroups, a catheter balloon, a glove, a wound dressing, a blood collection device, a blood storage container, a blood processing device, a plasma filter, a plasma filtration catheter, a device for bone or tissue fixation, a urinary stent, a urinary catheter, a contact lens, an intraocular lens, an ophthalmic drug delivery device, a male condom, a female condom, devices and collection equipment for treating human infertility, a pacemaker lead, an implantable defibrillator lead, a neural stimulation lead, a scaffold for cell growth or tissue engineering, a prosthetic or cosmetic breast implant, a prosthetic or cosmetic pectoral implant, a prosthetic or cosmetic gluteus implant, a penile implant, an incontinence device, a laparoscope, a vessel or organ occlusion device, a bone plug, a hybrid artificial organ containing transplanted tissue, an in vitro or in vivo cell culture device, a blood filter, blood tubing, roller pump tubing, a cardiotomy reservoir, an oxygenator membrane, a dialysis membrane, an artificial lung, an artificial liver, or a column packing adsorbent or chelation agent for purifying or separating blood, plasma, or other fluids.

### Manufacturing Examples

### Injection Molding of a Gasket

A gasket is processed using injection molding as follows. Polymer produced as in Example 3 is dried by flowing dry air at 180° F. until the water content is less than 0.01%. The dried polymer is then melted in an Arburg 320C Allrounder injection molder and charged into a cavity mold at 9000 psi. The injection cycle takes 3-10 seconds with a mold temperature of 80° F. Once the gasket is extracted from the mold, it is cured in a 100° C. oven for 24 hours to complete crosslinking between unreacted isocyanate groups and the hydroxyl groups from VORANOL.

### Compression Molding of a Spinal Disc

A prosthetic spinal disc is made through compression molding, as follows. Polymer produced as in Example 3 is dried by flowing dry air at 180° F. until the water content is less than 0.01%. The top platen temperature is set at 190° C. and the bottom platen is set at 180° C. A clean steel mold is sprayed with Teflon release agent. The steel frame is placed on the base plate and polymer is placed evenly within the frame. The top plate is then placed above the polymer and the entire mold is placed on the lower platen of the compression equipment. Pressure is increased to 6000 pounds until the polymer melts. The pressure is then increased to 19,000 pounds until polymer exits the side of the mold. Pressure is held for another 30 seconds at which time the pressure is relieved and the mold is placed in a bucket of water to cool. The polymer block is then removed from the mold and ready for machining into a prosthetic spinal disc. After the spinal disc is machined, final curing is completed by placing the disc in a 100° C. oven for 24 hours.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed but that the invention includes all equivalent embodiments.

What is claimed is:

1. A block copolymer having improved compression set, said block copolymer comprising a soft segment and a hard segment made from a diisocyanate, an alkylene diamine chain extender, and a multifunctional chain extender which provides delayed crosslinking.

2. The block copolymer of claim 1, wherein said multifunctional chain extender is has a functionality ≧3 and has at least one OH group.

3. The block copolymer of claim 1, wherein said multifunctional chain extender is an aliphatic or aromatic triol or polyol.

4. The block copolymer of claim 1, wherein said multifunctional chain extender is selected from the group consisting of polyether polyols, polyester polyols, acrylic and alkyd polyols, and mixtures thereof.

5. The block copolymer of claim 1, wherein said multifunctional chain extender is selected from the group consisting of glycerol, trimethylol propane, trimethylol ethane, pentaerythritol, ethanolamine, N-methyldiethanolamine, Mannich polyols, oxypropylated triols, sorbitol (hexahydroxyhexane), 2,2-bis(hydroxylmethyl)-3-propanol ether, and mixtures thereof.

6. The block copolymer of claim 1, wherein said multifunctional chain extender is a trifunctional polyol chain extender in which there are two primary alcohols and a one secondary alcohol.

7. The block copolymer of claim 6, wherein said multifunctional chain extender is a polyether triol chain extender that has the formula HO—X(OH)—OH wherein X is an polyalkylene oxide moiety.

8. The block copolymer of claim 7, wherein one of the OH groups in said polyether triol chain extender is a secondary alcohol.

9. The block copolymer of claim 1, wherein said multifunctional chain extender is a polyether chain extender that has the formula (H₂N)ₘ—X—(OH)ₙ wherein X is an polyalkylene oxide moiety and m and n are integers from 1 to 8.

10. The block copolymer of claim 9, wherein said multifunctional chain extender is a polyether chain extender that has the formula H₂N—X—(OH)ₙ wherein X is an polyalkylene oxide moiety and n is an integer from 1 to 8.

11. The block copolymer of claim 1, comprising 40-98 weight-% soft segment and 2-60% hard segment, in which 70-95% of the chain extender in the hard segment is difunctional and 5-30% is multifunctional.

12. The block copolymer of claim 1, wherein said soft segment is
NH₂(CH₂)₃—Si(CH₃)₂—O—[Si(CH₃)₂O]ₙ—Si(CH₃)₂—(CH₂)₃NH₂
wherein n=0 to 500.

13. The block copolymer of claim 1, wherein said diisocyanate has the formula OCN—R—NCO and is selected from the group consisting of alkyl diisocyanates, arylalkyldiiocyanates, alkyl-cycloalkyl diisocyanates, alkylaryl diisocyanates, cycloalkyl diisocyanates, aryl diisocyanates, and cycloalkylaryl diisocyanates.

14. The block copolymer of claim 1, wherein said alkylene diamine chain extender has the formula H₂N—R′—NH₂ in which R is a divalent alkylene moiety having from 2 to 20 carbon atoms.

15. A method for making a block copolymer having improved compression set in accordance with claim 1, which method comprises the steps of:
combining 40-98 weight-% soft segment component with 2-60 weight-% hard segment component, wherein, in said hard segment component, 70-95% of the chain extender is difunctional and 5-30% of the chain extender is multifunctional to form a partially crosslinked article; and
maintaining said partially crosslinked article at or below room temperature for at least 24 hours.

16. The method for making a block copolymer having improved compression set according to claim 15, which method includes the steps of:
providing a reaction vessel containing tetrahydrofuran solvent,
rapidly adding to said solvent in said reaction vessel, in the absence of catalyst, 45 weight-% PDMS 3345, 35 weight-% isophorone diisocyanate, 15 weight-% DYTEK A chain extender, and 5 weight-% VORANOL 230-660 chain extender, at 22° C., and
removing the resulting polymer from the reaction vessel after 15 minutes of adding the reactants thereto.

17. The method for making a block copolymer having improved compression set according to claim 15, which method includes the step of:
synthesizing in bulk using continuous reactive extrusion by metering into a twin screw extruder
80% PDMS 3345
15.5% IPDI
3.3% Dytek A
1.2% Voranol
at 190° C. with a screw speed of 200 rpm.

18. The polymeric product of the process of any one of claims 15-17.

19. The polymeric product of claim 18, configured as a prosthetic spinal disc.
